(19) United States
(12) Patent Application Publication
(10) Pub. No.: US 2012/0314268 A1
(43) Pub. Date: Dec. 13, 2012

(54) PACKAGE AND METHOD OF FORMATION

(75) Inventors: Igor Jermolajev, Rez-Husinec (CZ); Libor Kotacka, Rez-Husinee (CZ); Tomas Tethal, Rez-Husinec (CZ); Dvorak Robert, Rez-Husinec (CZ); Franc Peter, Rez-Husinec (CZ)

(73) Assignee: Optaglio s.r.o., Rez-Husinec (CZ)

(21) Appl. No.: 13/121,924

(22) PCT Filed: Oct. 1, 2009
(86) PCT No.: PCT/EP09/62790

§ 371 Date: Oct. 12, 2011

(30) Foreign Application Priority Data
Oct. 1, 2008 (GB) 0817865.9

(51) Int. Cl. G03H 1/00; B29C 35/08; B29C 63/02

(52) U.S. Cl. 359/2; 156/198; 264/400

(57) ABSTRACT

The present invention provides for a device package comprising an element secured to a plastic body, the element having at least one opening into which material of the plastic body extends to at least assist with securing the element to the body.

The present invention relates to the provision of a package and in particular, but not exclusively to an optical device package having an optical element secured within a plastic body.

As will be appreciated from the following, in one example the invention can provide for a perforated relatively thin foil being embedded in a thermoplastic media.

It is well known from physical chemistry as and related disciplines that, for example, metals and various thermoplastic such a e.g. polycarbonate have a different surface adhesion. In other words, they are difficult to be mutually attached. In spite of this, encapsulating the metal body into a bulk of a thermoplastic material can prove sufficient for certain applications. However any perturbation of the material may allow the metal element to be easily removed from the plastics. This may be difficult to accept from an industrial point of view (causing a potential injury etc.). In particular, however it can prove unacceptable if the encapsulated metallic element is arranged to carry forensic information such as a hologram and so on. Such a device would then be easily fractured and the security hologram removed with minimal effort.

The invention seeks to provide for an embedding arrangement and method having advantages over the current art.

According to one aspect of the present invention a device package comprising an element secured to a plastic body, the element having at least one opening into which material of the plastic body extends to at least assist with securing the element to the body.

The invention can advantageously provide for irreversible embedding of, for example metallic bodies into various thermoplastics.

This invention is based on the provision of for example a perforated metallic foil, which is then laminated into the plastic material. The foil can actually be any foil having higher melting point than the outermost media (even ordinary holographic plastic foils, hence not only metallic)—i.e. embedding media, and having openings or perforations through which that media extends when softened.

Such arrangements can be used for such tasks such as when a certain material (e.g. metal plate) is to be located inside another for example such as a thermoplastic material. The invention also provides for the manufacture and composition of articles containing a new security device, i.e. when the embedded perforated foil-like plate bears holographic information or when the foil is perforated in such way that can be read by means of the electromagnetic radiation, or the parts of the foil are arranged in such a way features that can be detected by means of the optical tomography or a radar assisted technique, as an example.

Within the present application it should be appreciated that reference to aplastic body is to a body that can offer, at least in some circumstances a degree of plasticity.

Also, reference to an opening in the said element encompasses both a blind bore within the element and a complete opening passing through the element.

The invention is described further hereinafter by way of example only, with reference to the accompanying drawings, in which:

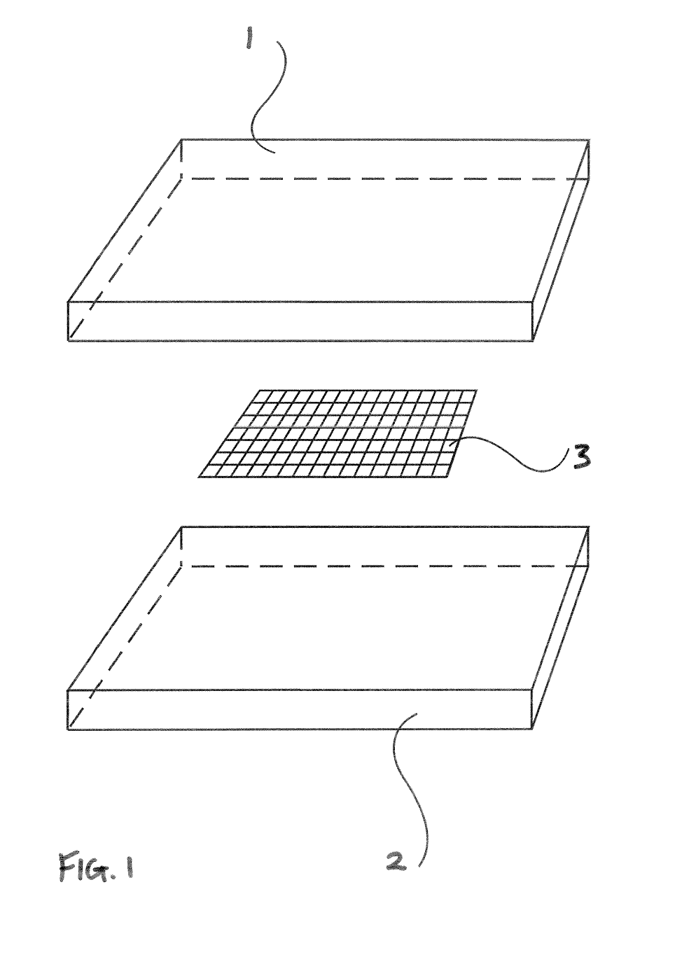

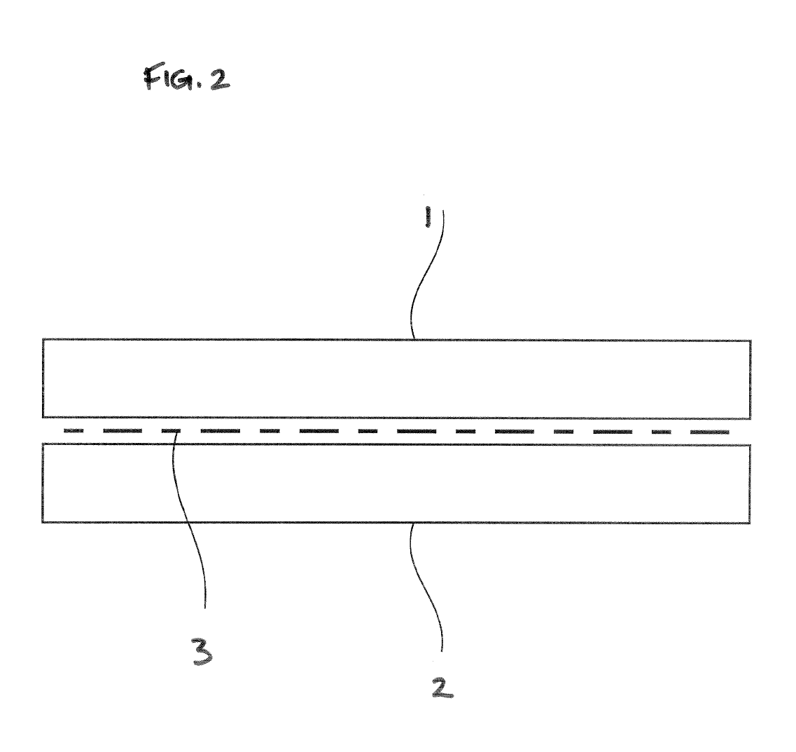

FIGS. 1-3 illustrate stages in the production of an embedded element according to an embodiment of the present invention;

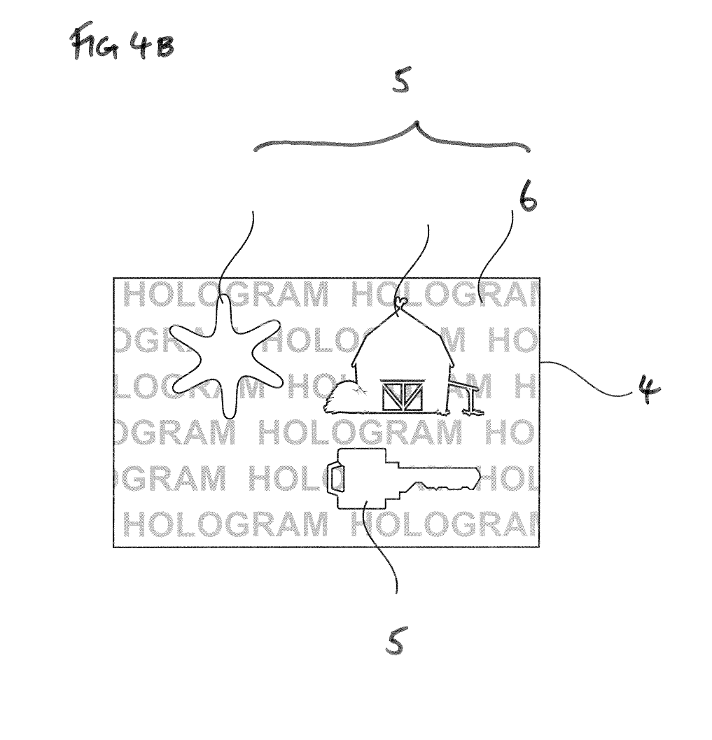

FIGS. 4a and 4b illustrate features of one particular element according to an embodiment of the present invention;

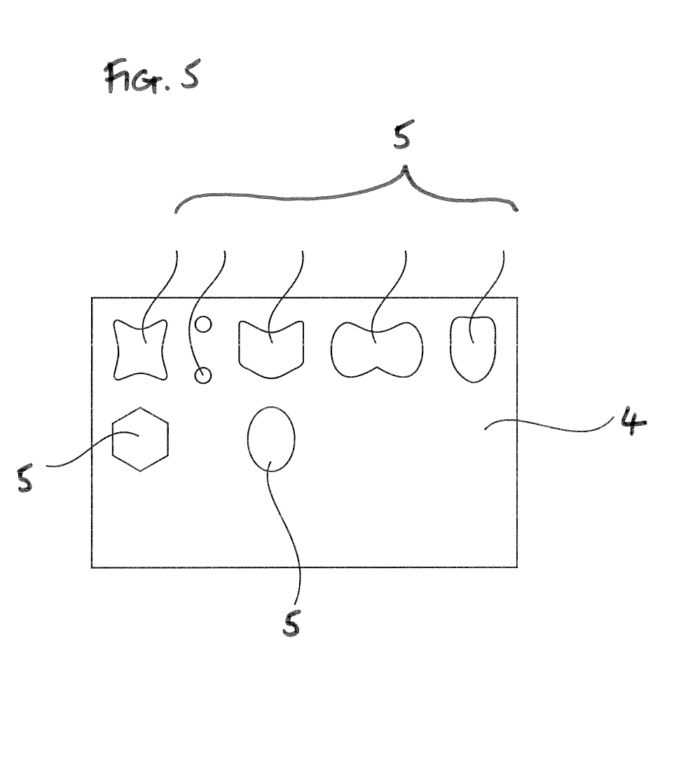

FIG. 5 illustrates features of an element according to another embodiment of the present invention;

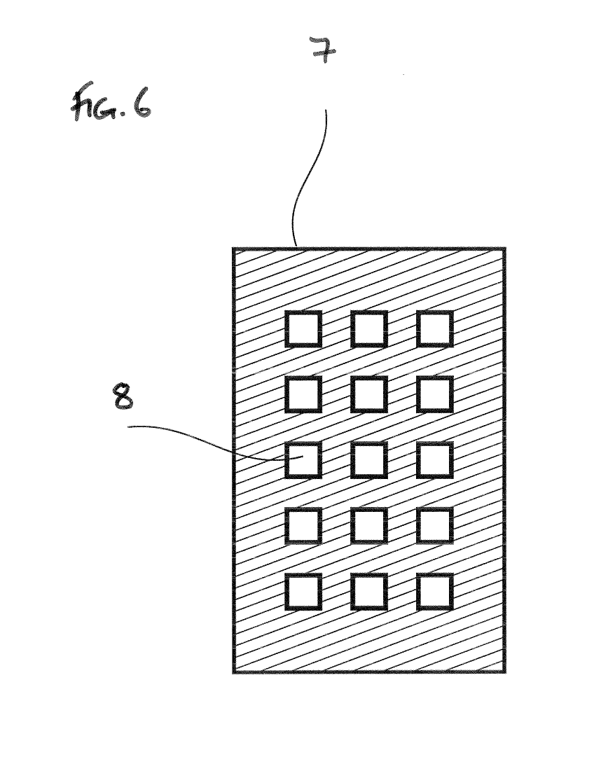

FIGS. 6-11 represent plan views of elements to be embedded in accordance with further embodiments of the present invention;

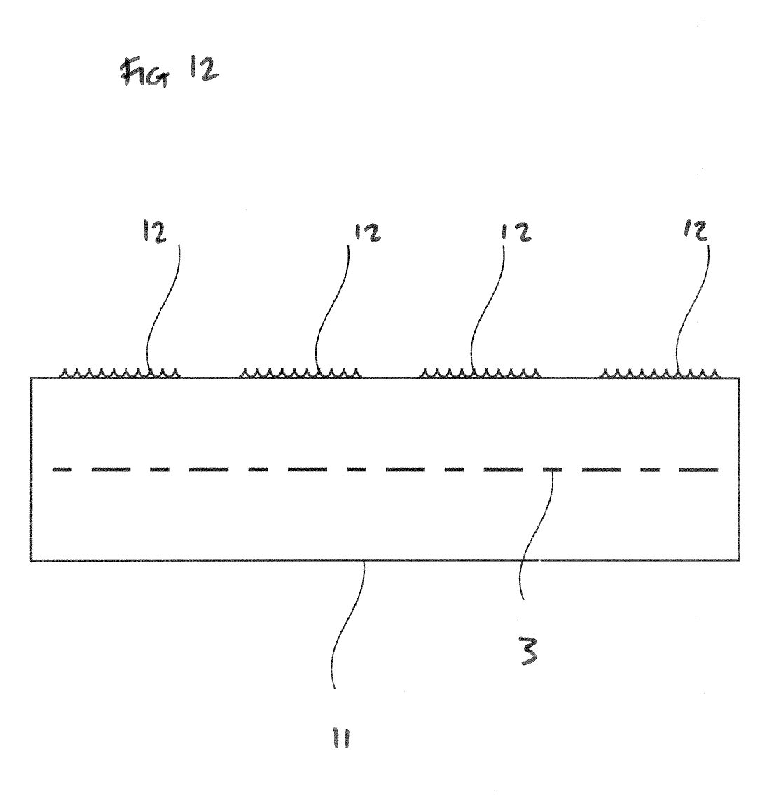

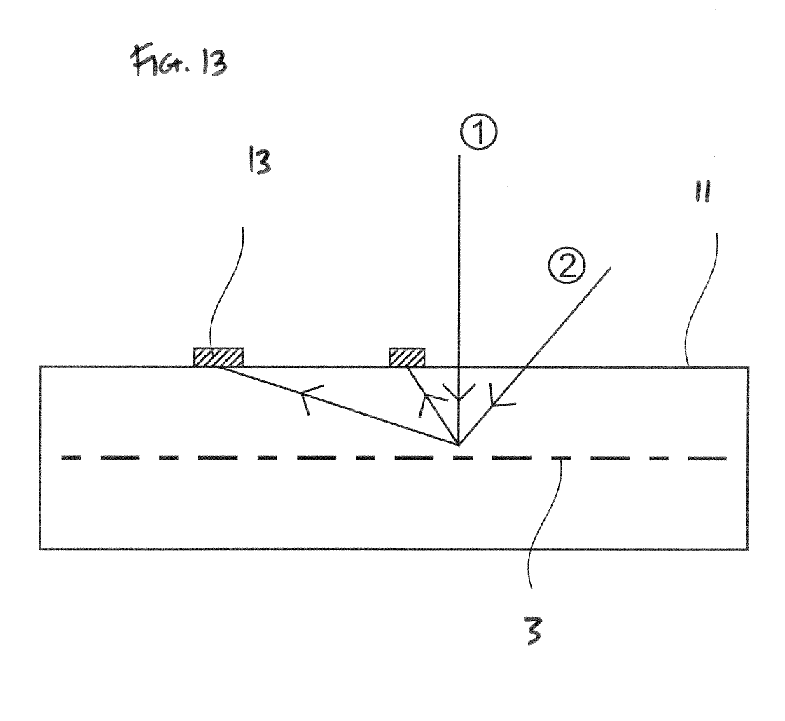

FIGS. 12 and 13 illustrate a schematic sectional views through identification cards including embedded elements so as to comprise embodiments of the present invention;

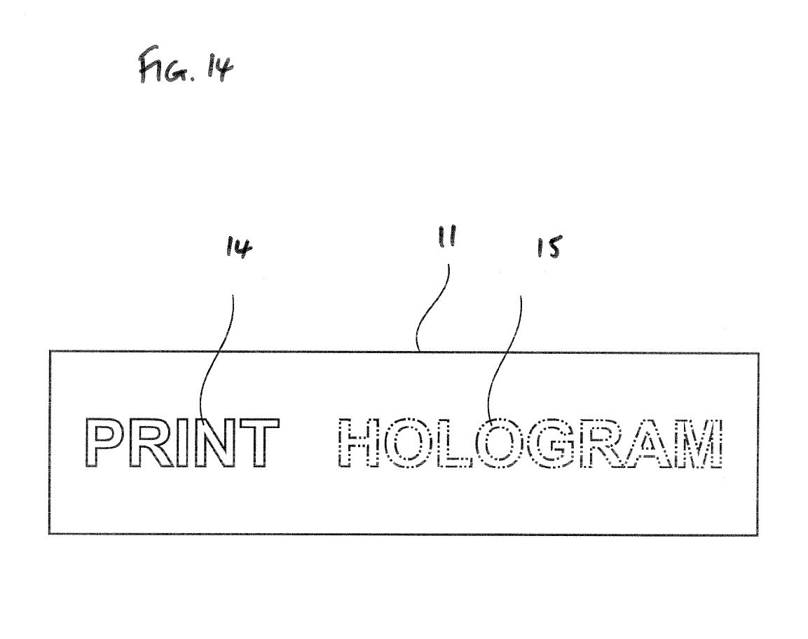

FIG. 14 is a plan view of a further embodiment of the present invention;

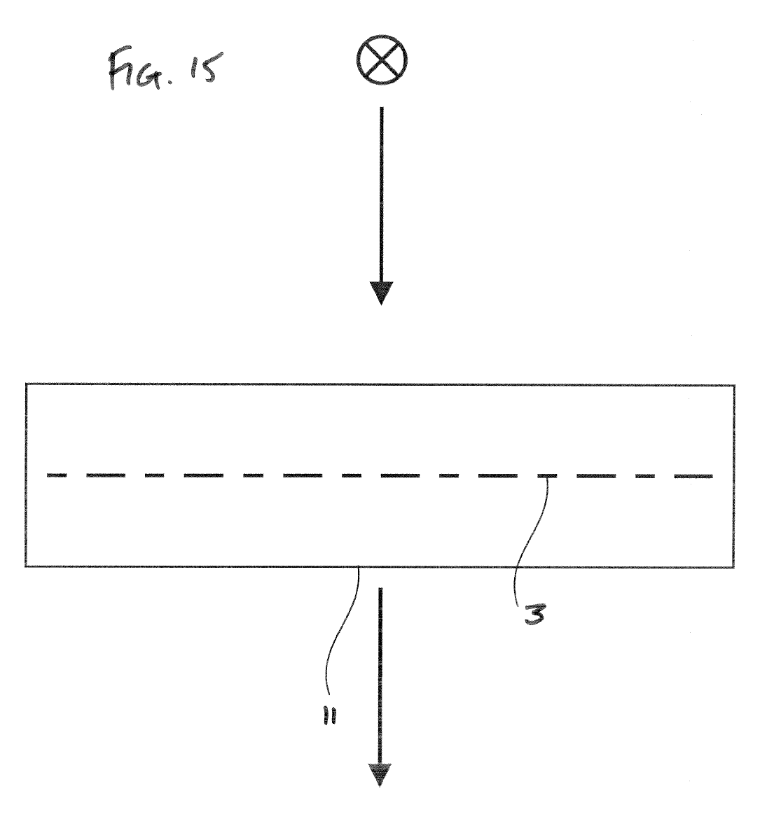

FIG. 15 is a further schematic sectional view through a ID card according to a further embodiment of the present invention;

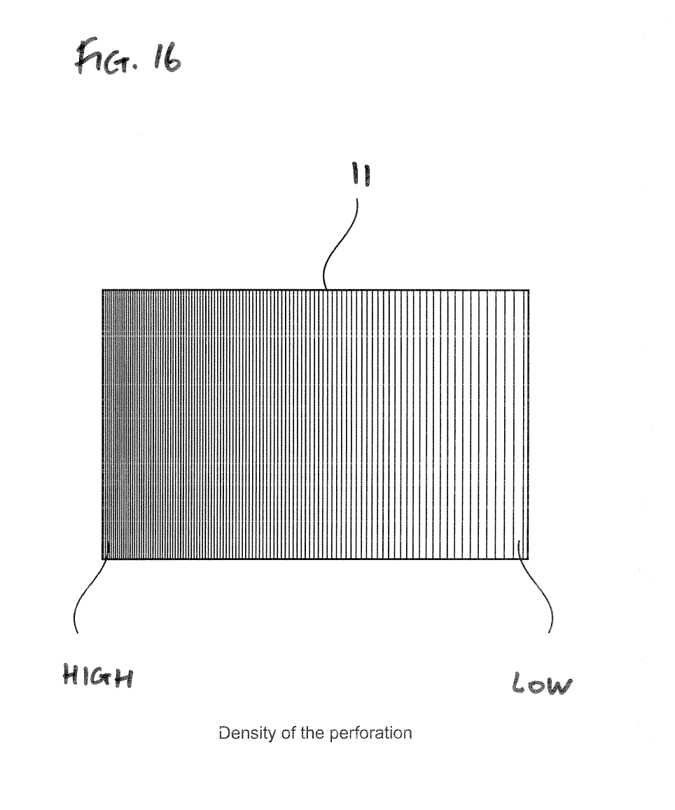

FIGS. 16-19 illustrate embodiments of the present invention in which the spacing of openings is controlled so as to achieve required diffractive/reflective effects.

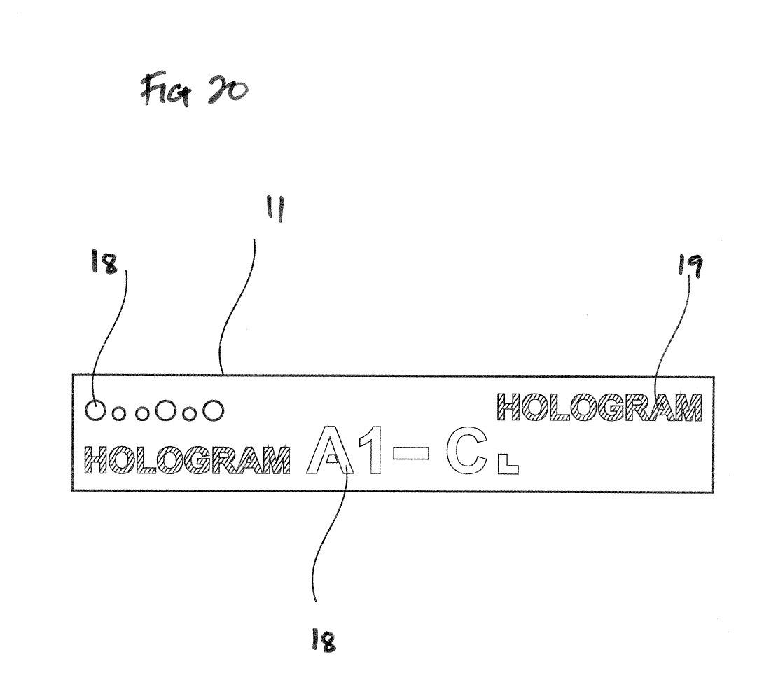

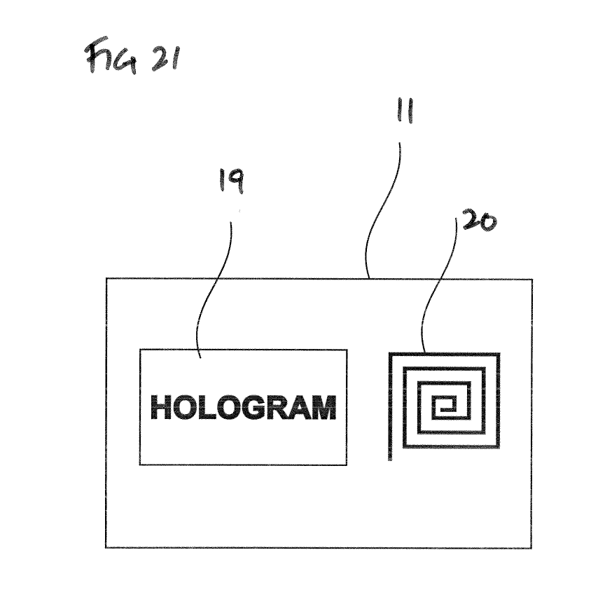

FIGS. 20 and 21 are schematic views of further embodiments of the present invention;

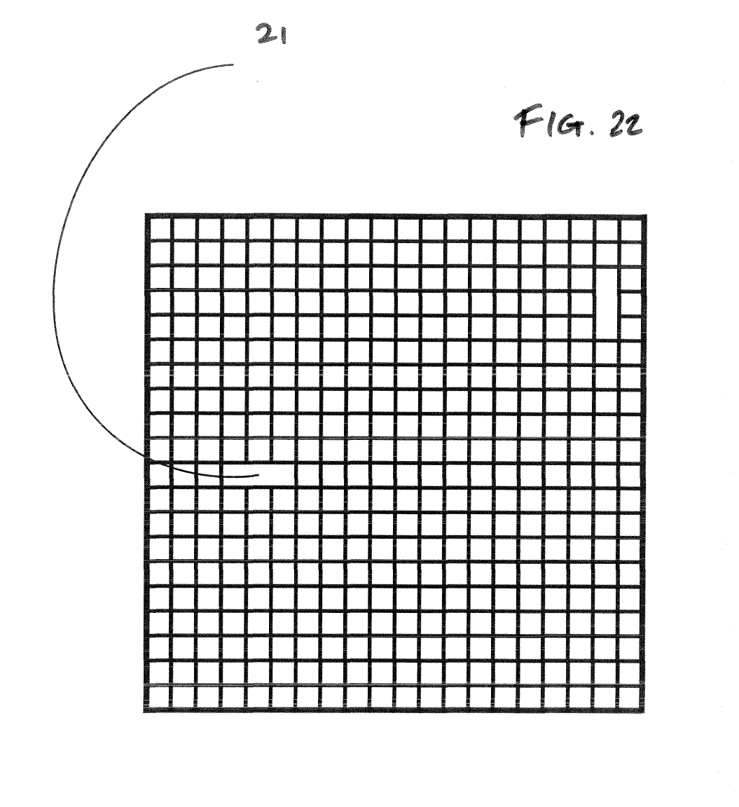

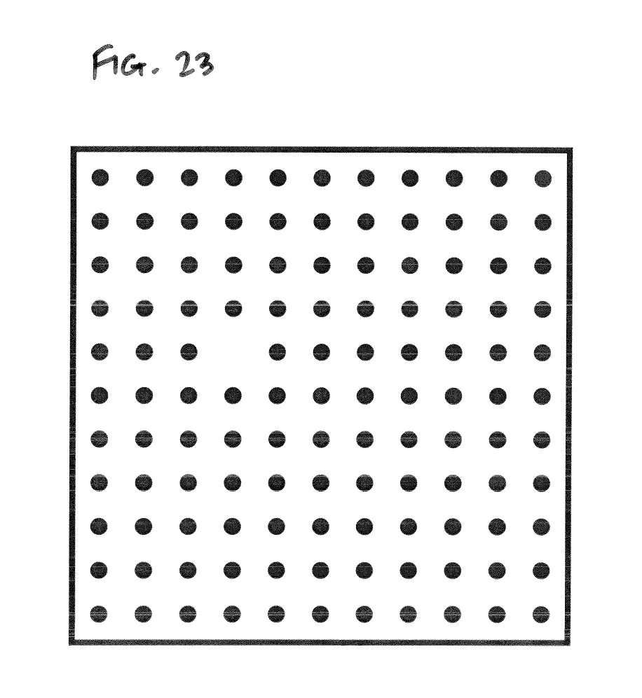

FIGS. 22 and 23 are plan views of elements that can be embedded in accordance with the present invention and in which whatever data is incorporated;

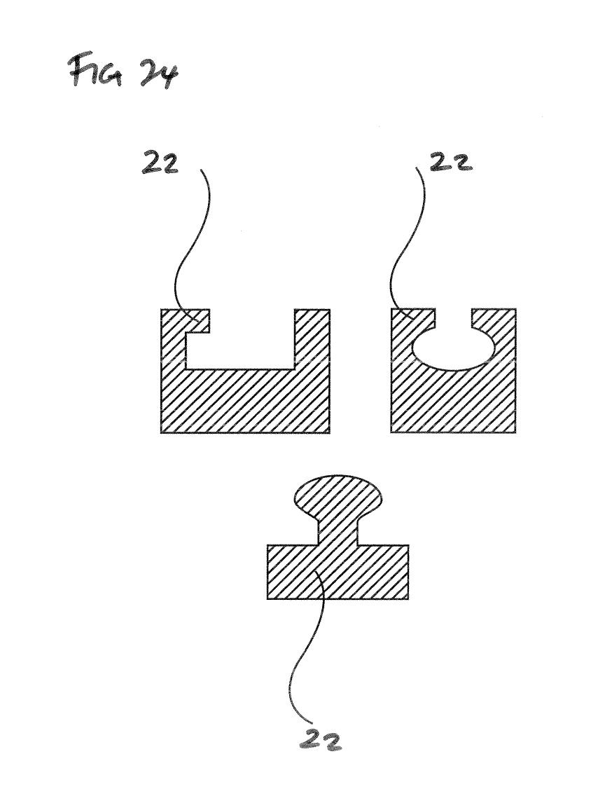

FIG. 24 provides an illustration of different versions of partially etched foil according to embodiments of the present invention; and

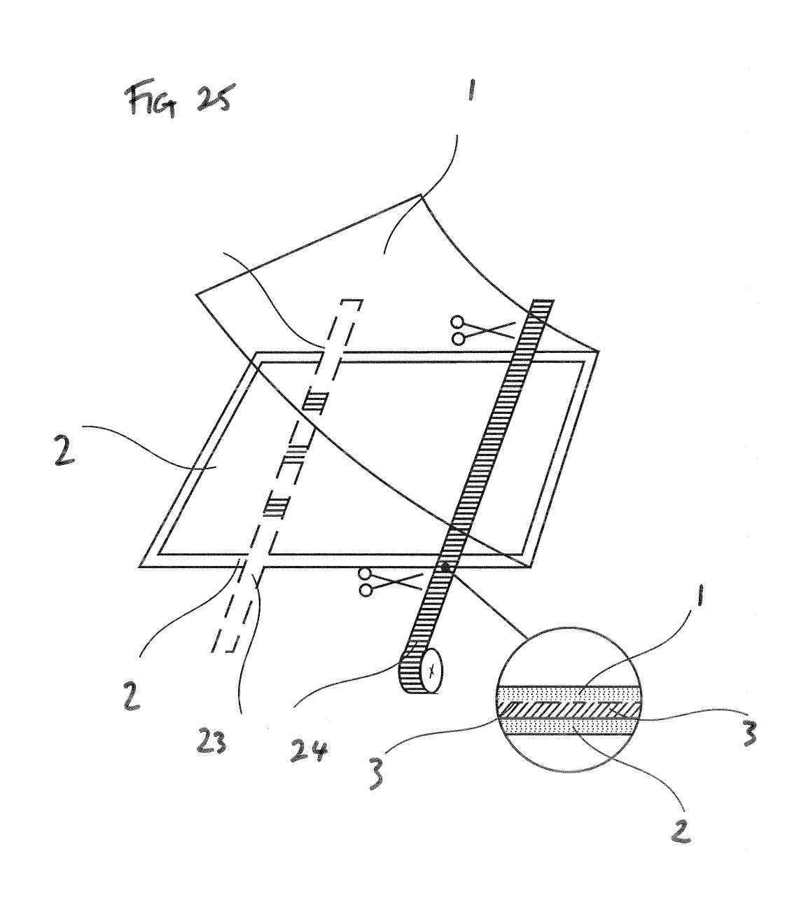

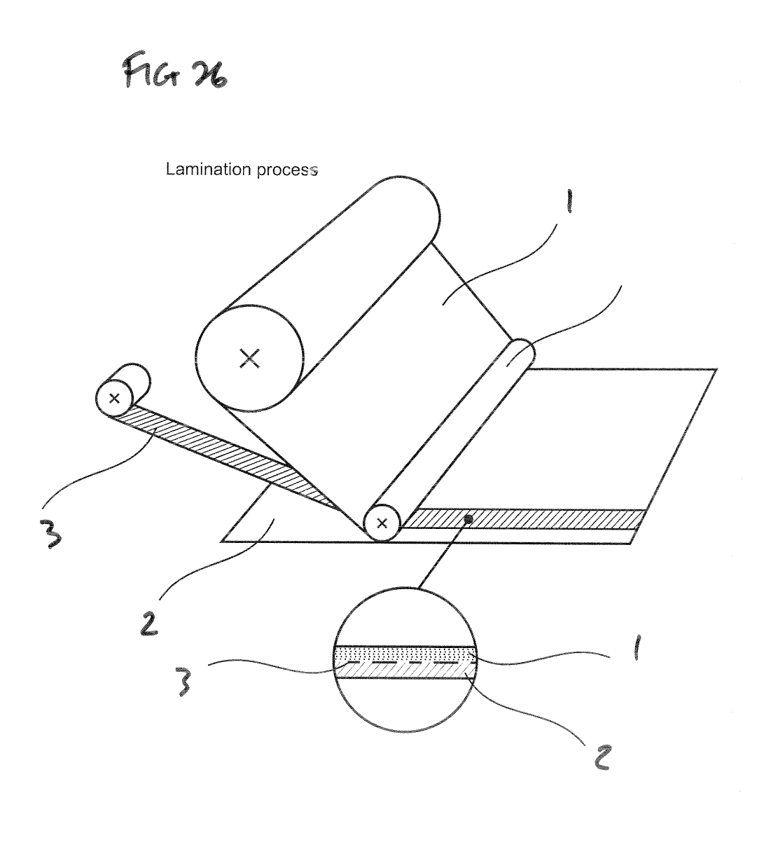

FIGS. 25 and 26 provide illustrations of examples of methods of production of packages according to embodiments of the present invention.

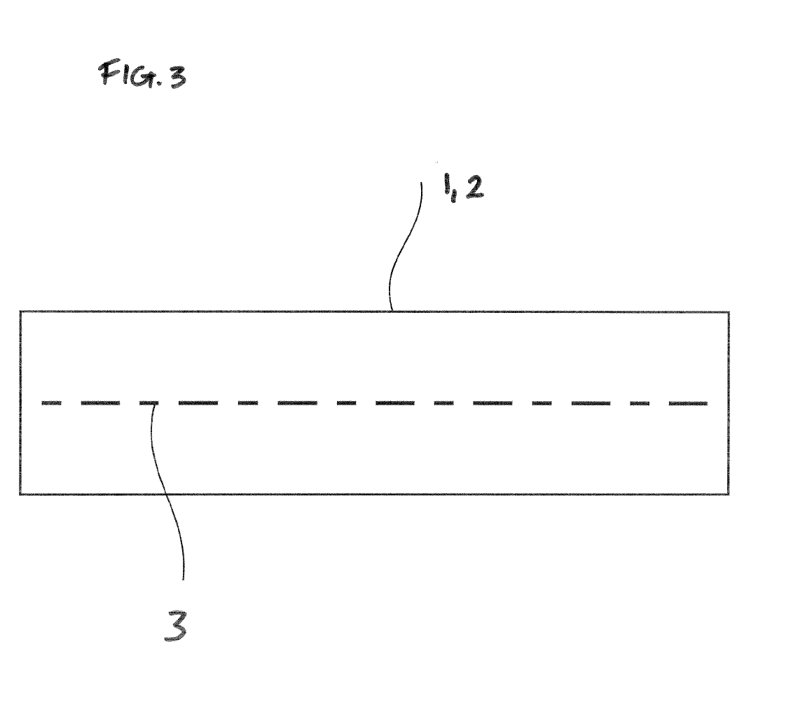

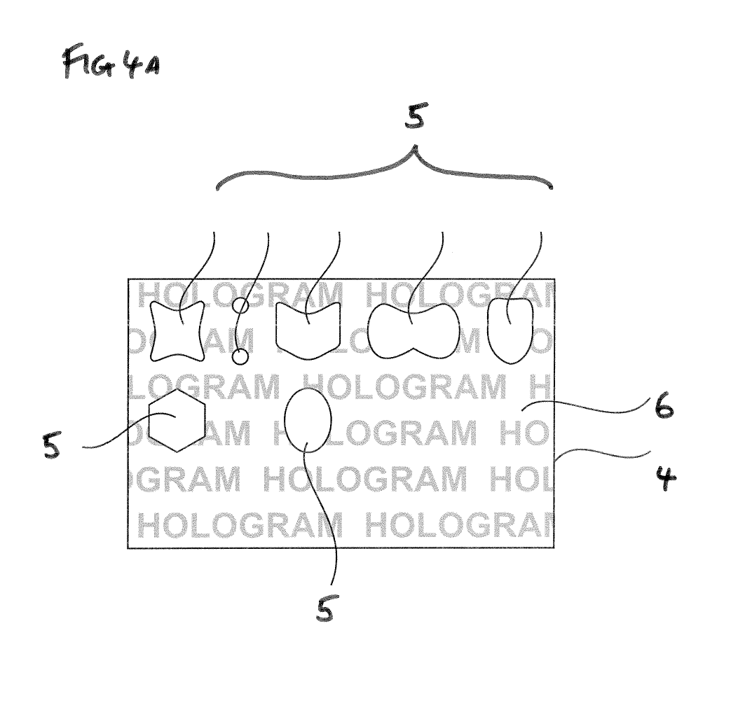

FIG. 1 shows the first step prior to the lamination and relates to a two-layer structure. In this example layer 1 and layer 2 are either transparent of semitransparent or nontransparent thermoplastics or reactoplastics, such as Polycarbonate, Polyethylen, Polyethylen terephtalate, polyvinylchloride, and polymethylmetacrylate, epoxides and others. A prefabricated thin foil 3 of desired size, relatively thin, say from 1 micron to even few millimeters is then provided. Thicknesses of 5 to 15 microns are likely to be most common. Using a standard laminating procedure, layer 1, and layer 2 are partially melted, or at least softened, through application of an appropriate pressure and temperature. If required however, the foil can be initially located on the layer(s) by chemical means prior to lamination and embedding. A cross section of this procedure just prior to laminator is depicted in FIG. 2. Layers 1 and 2 thus create a homogenous or quasi-homogeneous media 1, 2, as they have been merged through the openings in the foil 3 and this is illustrated in FIG. 3. Thus the perforated foil 3 referred to herein also as a web, or web plate, lets the soft plastics enter the openings and, after decreasing the lamination temperature, causes locking of the foil 3 in between layers land 2. This can be achieved through any appropriate openings in the foil 3 which allow for “keying” of the plastic material and the technique detailed in WO 2005078530 for openings having microscopic sizes and arbitrary shapes is particularly suitable.

The characteristic size of each opening can be as small as 1 micrometer although in many examples the dimensions will be in the order of 80 microns or greater. The openings can be produced by way of a galvanoplastic or related technique (electrogalvanic etching etc.). The total area of such web can be from as small as few tens of micrometers squared to nearly unlimited sizes (even squared meters). FIGS. 4A, 4B and 5 illustrate examples of such openings 5.

The web plate 3, 4 can contain several openings of a variety of shapes 5 (even depicting simple graphics), and the remaining area 6 can be with or without a surface hologram. A very basic example of see-through web is shown on FIG. 6. The hatched surrounding area can be made of metal of any material, if required according to the teaching of WO 2005078530 and related galvanic approaches or can be perforated mechanically (particularly for standard holographic foils) or any combination thereof. The perforation 7 can also be achieved by a laser engraving, micromechanical or etching technique. The distance between such illustrated openings is likely to be about 10 microns.

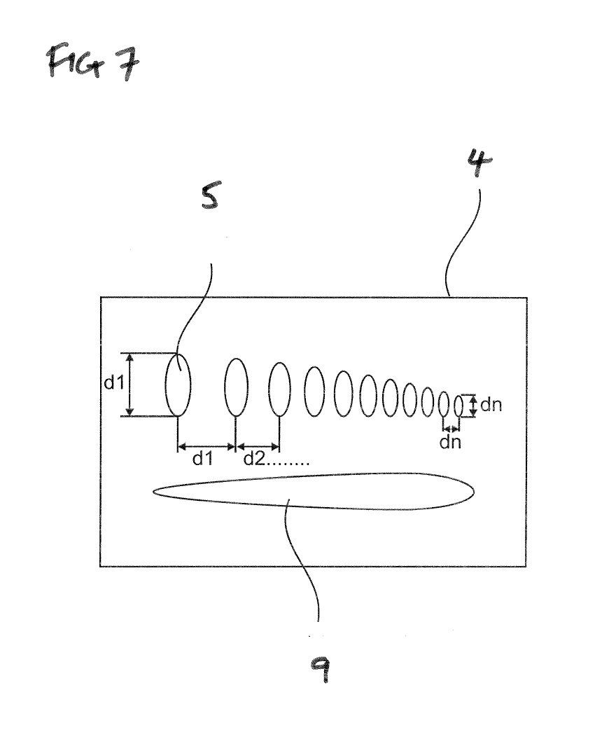

FIG. 7 again shows a variety of possible openings. They can be of relatively arbitrary shapes and sizes such as ellipses 9 etc. Alternatively, the opening can be preferably arranged in a manner having a certain mathematical prescription, e.g. defined way of changing the sizes and distances d1, . . . , dN, D1, . . . , DN, (and which is to be through a constant of functional increment) what may express certain information or code, and which is to be read in a later inspection step. It should of course be appreciated that the end which is to be size of the openings and the distances separating them are quite independent and can be common or differ as required.

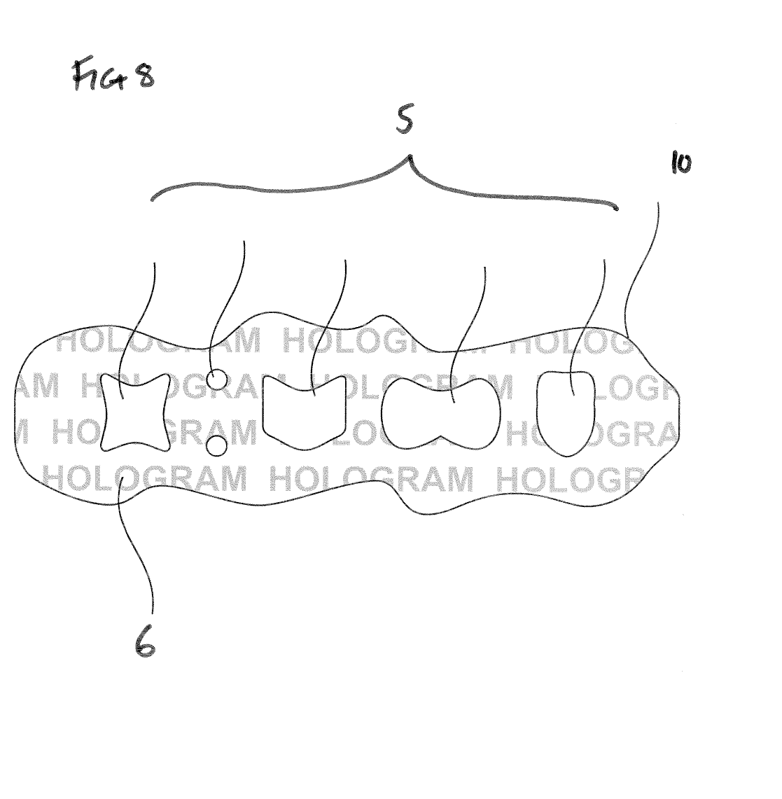

Another possibility is to functionalize the boundary 10 of the web 3 as shown in FIG. 8 and so as to provide for a required shape and graphics etc.

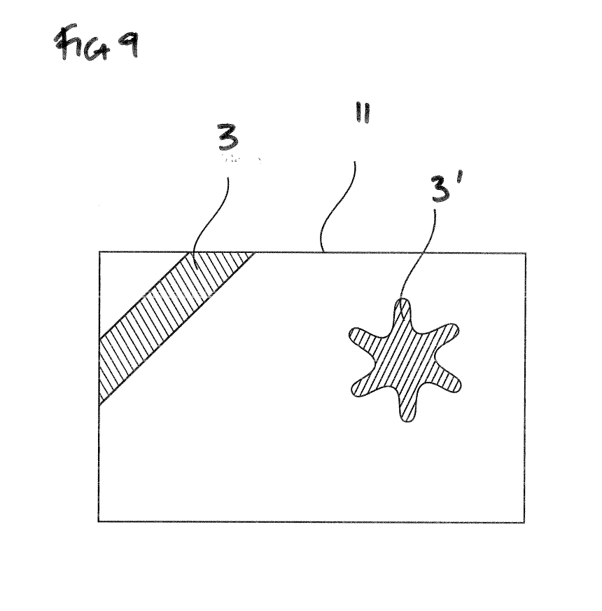

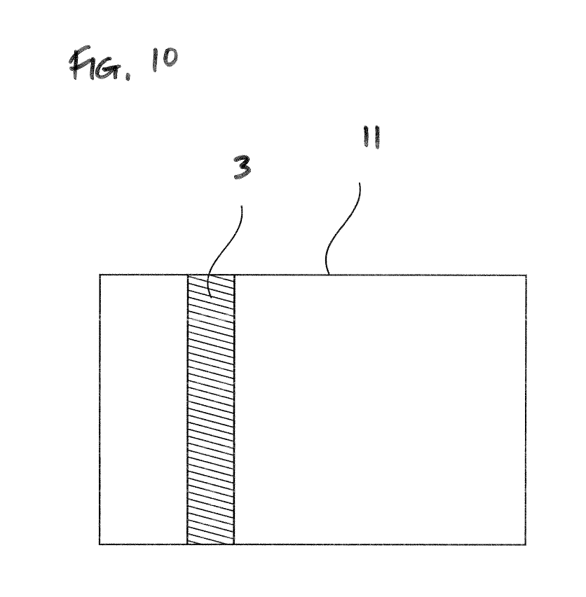

Such devices preferably can serve as protection diffractive devices in various items of value such as for example identification cards, credit cards, banknotes etc., where the web 3 is embedded in the plastic body and so being thus extremely difficult to counterfeit and such as shown in FIGS. 9 and 10. The embedded material can also be provided as a frangible mosaic 3 designed to fracture if mechanically disturbed. Such devices can be incorporated into the card 11 and so as to comprise either the entire area of the card of just a defined part of it. Finally the web can be embedded in to a plastics body to serve in automotive lighting arrangements/systems etc. (to demarcate the path of the beam, or to be there simply from a security point of view), such that the product taken on the form of metal portions (wires) embedded in a transparent media and the accuracy can be an order of microns during the processing of the product.

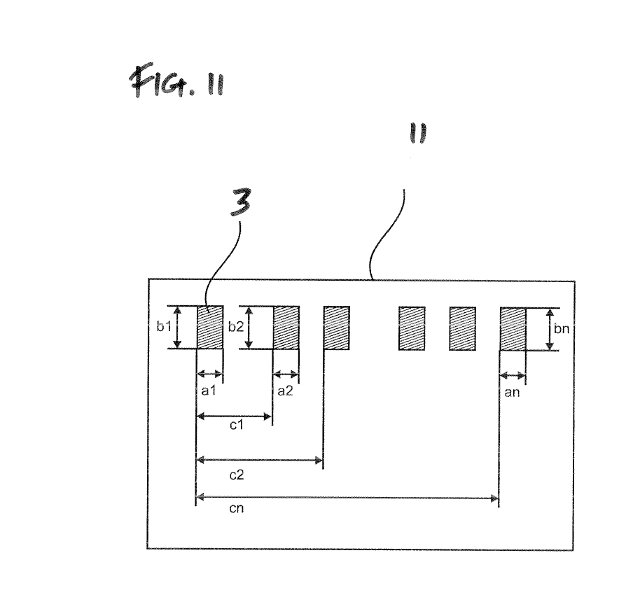

Turning now to FIG. 11, there is illustrated an example of a card 11 serving to exploit a specifically given spatial arrangement of several webs 3 and each having sizes aj, bj. (j=1 . . . N), with a distances c1, . . . , cN. This is an analogy of a conventional printed bar code or PDF417. Because of the conductive nature of the web 3, such arrangement is easily recognized by an advanced technique as radar assisted signal acquisition, synthetic aperture radar technique. On the other hand, such code can also be read through optical tomography, especially when an embedded holographic foil exhibits dielectric properties. It should be appreciated that the above techniques allow for determination of real 3D reconstruction of the code position i.e. not only in lateral directions. This code in both cases, i.e. metallic and dielectric nature, may be accompanied by a hologram, that can exhibit a novel feature in such coding.

Of course the whole pattern of the metal element can be formed of sub-elements defined via the system of FIG. 11 and so as to comprise a mosaic.

FIG. 12 shows a whole product, where an additional hologram, DOVID etc 12 is added on top of the device such as an ID card 11. Another feature can be used to introduce the light into the card body. The diffractive structure on the web 3 can then serve to reflect, or diffract, the light, as for example it impinges on an element 13 on top of the card, e.g. optically variable ink, that can serve to change its colour for an example as shown in FIG. 13. Of course due to of a total internal reflection, the light can be further guided inside the plastic card.

In another example, the entire card 11 can bear a complex code or label, which may be partly printed 14 in a traditional way, and partly depicted through a specifically shaped web that can also exhibit a hologram 15 such as in FIG. 14. Further the feature can be in the shape of a machine readable code, such as for example standard bar codes. It can also be overprinted by means of laser writing into an inner layer inside the element, or indeed any combination of the above.

Another advantageous property is the possibility of governed transparency of the web. In particular, the openings can be so small, that they are unrecognized by the naked eye. Thus a defined density of (micro) openings can serve to change the transparency of the entire device, like ID. This is schematically shown in FIG. 15. Further, an example of the continuously changing density within a card 11 is shown in FIG. 16. It is therefore possible to control the transparency with an accuracy of 1 percent. Of course, if required, governed reflection can also be achieved through such change in density of the (micro) openings, and it can prove possible to write 2D graphs of grey level object/motif.

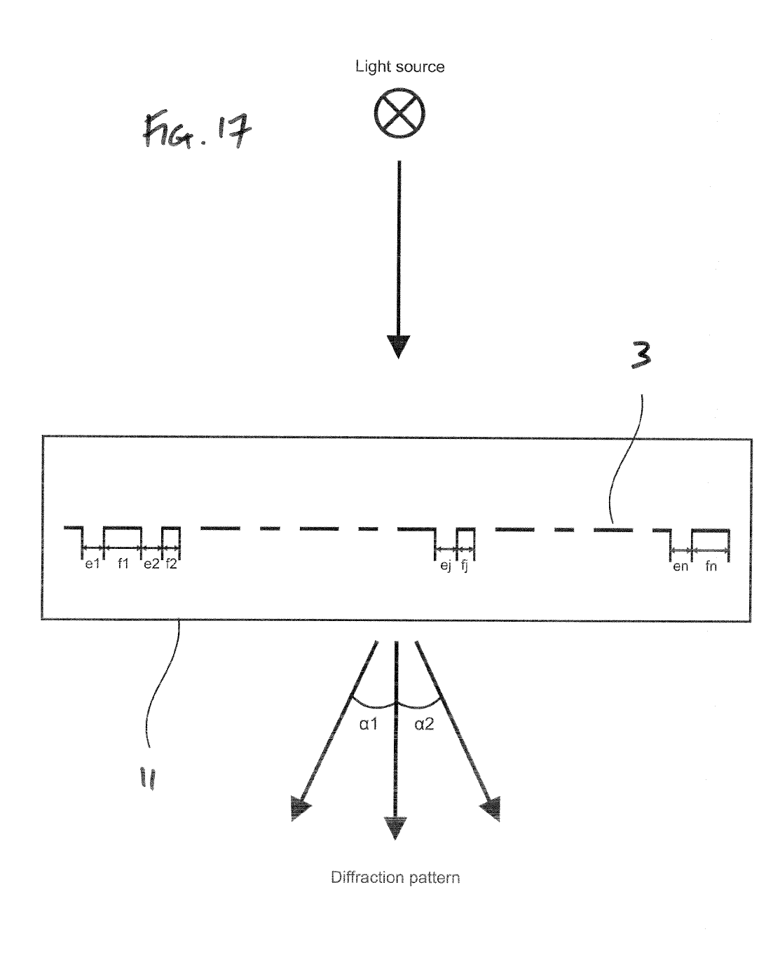

It should further be appreciated that the openings in the web can readily be arranged in such a way that when illuminated by a partially coherent light source, they yield a diffraction pattern (including diffraction orders under extra angles), that may be further detected as appropriate. The web openings can be defined, i.e. arranged, laterally on plane of the card according to a given function f(x,y), and the diffraction pattern would then be a function of the Fourier transform of such function. This offers a unique forensic feature of distant control. For examples comprising generally metallic webs having and characteristic sizes of openings and their spacing (ej, fj)—from microns and greater values, the web can be inspected for verification via a broad spectrum of frequencies, from visible spectrum, through infrared and microwaves to even radio waves, say millimeter/centimeter waves and reference is made here to the card 11 of FIG. 17. Of course the openings can be determined to cause diffraction of related phenomena for a light source of a pertinent wavelength with respect to the size of the openings.

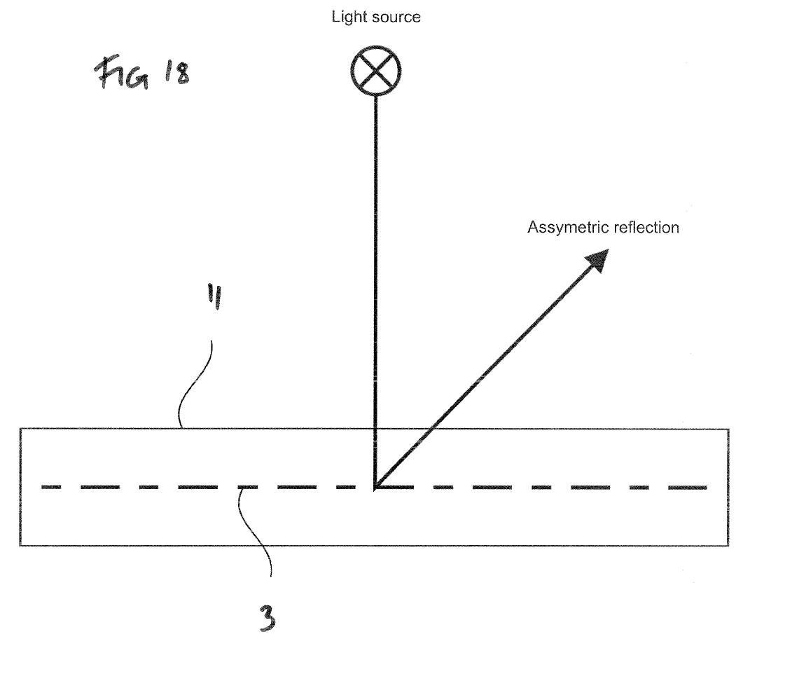

Another option is a use of covert laser readable images of simply asymmetric gratings located on the web. This will cause an asymmetric reflection of incident light and is illustrated with reference to FIG. 18.

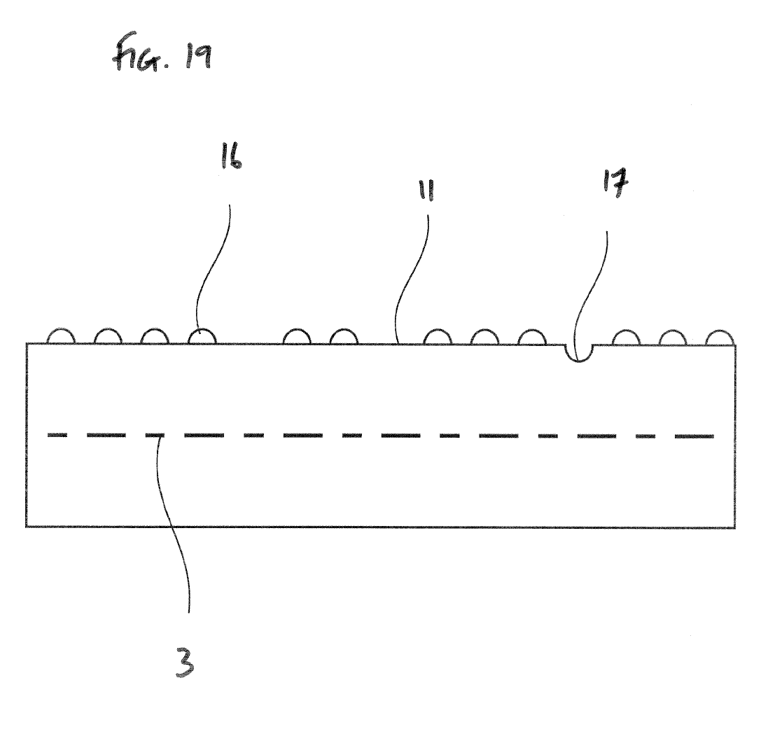

The whole device can be further post-processed in order to add a personal data etc. Further it can be marked 16 by an optically variable ink, overprinted, overprinted with intaglio technique, on the other hand the surface can be laser engraved 17 as illustrated in FIG. 19.

Further, a laser-sensitive layer, if present, within the card, can be written to as required and so as to add-in further data and images as required.

The web-device can carry a variety of elements in one design such as openings 18 in a code style, holographics elements 19, and microscope readable alphanumerical code, or simply readable by the naked eye and as illustrated in FIG. 20.

In a further example, the web embedded in the plastic card 11 can also play a role of a conventional RFID chip and antenna 20, thus adding it possible extra forensic features and as illustrated in FIG. 21.

Indeed the elements can be serve as any required conductive path or circuit element such as planar inductors of antennae, conductive couplers, capacitors etc. While schematically shown in FIG. 21, these features can be provided at different levels through a multilayered structure by a repeat of the lamination of FIGS. 1 to 3.

FIGS. 22 and 23 show extra forensic features 21, i.e. introducing a driven perturbation in onto a periodic of quasiperiodic layot of the web 3. This can be done directly in the production itself, or via external laser engraving of simply achieved via mechanical means.

It should however be appreciated that FIGS. 22 and 23 introduce a specific way of a perturbation of the mesh/web. The missing details can be either code(s) themselves or they can pre-indicate a location wherein the “post-expo” finalization should be performed. Such finalization can comprise, for example, a high-power laser assisted demarcation and separation of those sub-elements of the above mentioned mosaic. Any required laminating step can also serve to efficiently separate the various elements of the mosaic so that they can ready “fall apart” if later disturbed by attempted access into the package structure.

FIG. 24 illustrates a “semi-way” of etching 22 the metallic web 3 to allow for appropriate “keying” of the plastics material even in situations where a “see-through” element is desired and as illustrated a cross section of such web can be achieved via anizotropical etching in order to obtain such shapes, like cavities or complimentary shapes, enabling a proper embedding of the web 3.

FIG. 25 illustrates a way of laminating such devices where the web can be either in continuous stripe of in a discrete form, and a so called roll-to-roll lamination is illustrated in FIG. 26

1. A device package comprising an element secured to a plastic body, the element having at least one opening into which material of the plastic body extends to at least assist with securing the element to the body.

2. A package as claimed in claim 1, wherein the element comprises a foil element.

3. A package as claimed in claim 1, wherein the element comprises a metallic element.

4. A package as claimed in claim 1, wherein the element comprises a plastic element.

5. A package as claimed in claim 1 wherein the element includes a diffractive/holographic structure.

6. A package as claimed in claim 5, wherein the said diffractive/holographic structure is provided on opposite sides of the element.

7. A package as claimed in claim 1, wherein the element serves to define at least part of a light-path through the package.

8. A package as claimed in claim 1, wherein the element includes a DOVID.

9. A package as claimed in claim 1, wherein the element has a data printed thereon.

10. A package as claimed in claim 9, wherein the data is printed by way of optically variable ink.

11. A package as claimed in claim 1, wherein the element comprises a conductive electronic circuit element.

12. A package as claimed in claim 1, wherein the body comprises thermoplastic media.

13. A package as claimed in claim 1, wherein the body comprises a reactoplastic media.

14. A package as claimed in claim 1, wherein the body is at least one of the transparent, semi-transparent, or opaque.

15. A package as claimed in claim 1, wherein the at least one opening comprises at least one perforation in the element.

16. A package as claimed in claim 1, wherein the said opening comprises a microscopic opening.

17. A package as claimed in claim 1, wherein a plurality of openings are provided comprising arbitrary shapes.

18. A package as claimed in claim 1, and including an opening serving to define a graphic indicia.

19. A package as claimed in claim 1, and having a plurality of openings at a density serving to control the transparency/reflectivity of the element.

20. A package as claimed in claim 1, wherein at least one opening serves to define coded information.

21. A package as claimed in claim 1, wherein at least one opening serves to define security and/or anti-counterfeit information.

22. A package as claimed in claim 1, wherein a plurality of openings is provided and serving to yield a diffractive pattern.

23. A package as claimed in claim 1, wherein the said element is embedded within the body.

24. A package as claimed in claim 1, and including a plurality of the said elements.

25. A package as claimed in claim 1, wherein the element comprises a frangible mosaic of sub elements.

26. A package as claimed in claim 1, wherein the element comprises an optical element and the device package comprises and optical device package.

27. A package as claimed in claim 1, and comprising or forming part of an anti-counterfeit device.

28. A package as claimed in claim 1, and comprising a monetary element or coinage.

29. An element for securing to a body for forming a device package, the element having at least one opening arranged for receipt of material of the body to at least assist with securing of the optical element to the body.

30. An element as claimed in claim 29, wherein the said at least one opening is arranged for locking the element to the body and for defining feature thereof.

31. An element as claimed in claim 29 and including a diffractive/holographic structure.

32. An element as claimed in claim 29, and arranged for incorporation into a package.

33. A method of forming device package having an element and body, the method comprising the steps of providing an element having at least one opening, locating the element adjacent material of the body, softening the said material of the body and causing it to extend into the said at least one opening and subsequently allowing the softened material to harden so as to at least assist in securing the element to the body.

34. A method as claimed in claim 33, wherein the material of the body covers at least one side of the element.

35. A method as claimed in claim 33, wherein the material of the body covers opposite sides of the element.

36. A method as claimed in claim 33, wherein the element is embedded within the body.

37. A method as claimed in claim 33, wherein the element is provided with the said at least one opening by a galvanic, mechanical or laser-engraving process.

38. A method as claimed in claim 33 and including a plurality of elements within the body so as to for a multi-layered package.

39. A method as claimed in claim 33, arranged for forming a device package.

40. A method as claimed in claim 33 and including the steps of laser writing to a laser-sensitive layer within the package.

41. A method of forming an item of value and comprising forming a device package as claimed in claim 33, and attaching the package to the item of value.

42. A method of forming an item of value and comprising forming an device package as claimed in claim 33, and forming the package integral with the item value.

43. A method of forming an element for combining with a body so as to form an device package including the step of forming at least one opening in the element for receipt of material of the body therein so as to secure the element to the body.

44. A method as claimed in claim 43, wherein at least one opening is formed for locking the element of the body and for providing a feature pattern of the element.

45. A method as claimed in claim 43, and including the step of forming a diffractive/holographic structure in the element.

46. A device as claimed in claim 1 wherein the said at least one opening extends completely through the said element.
